(19) United States
(12) Patent Application Publication
(10) Pub. No.: US 2001/0032318 A1
(43) Pub. Date: Oct. 18, 2001

(54) Apparatus and method for protecting configuration data in a programmable device

(76) Inventors: Kun Wah Yip, Kowloon (HK); Tung Sang Ng, Pokfulam (HK)

Correspondence Address: David B. Cochran, Jones, Day, Reavis & Pogue, North Point, 901 Lakeside Avenue, Cleveland, OH, 44114, US

(21) Appl. No.: 09/728,520

(22) Filed: Dec. 1, 2000

Related U.S. Application Data
(60) Provisional application No. 60/168,951, filed on Dec. 3, 1999.

(51) Int. Cl. G06F 12/14

(52) U.S. Cl. 713/190

(57) ABSTRACT

A method an apparatus for protecting a configuration data sequence from reverse engineering is provided. The configuration data sequence includes a plurality of configuration bits and is used to configure the operation of a programmable device, such as an FPGA or other reconfigurable logic. According to a method of the present invention, the configuration bits of the configuration data sequence are partially encrypted by altering some, but not all, of the bits, and subsequently storing the partially-encrypted configuration data sequence external to the programmable device. Corresponding decryption information is then stored within the programmable device, which decrypts the partially-encrypted configuration data sequence using the decryption information stored therein to thereby configure internal logic of the programmable device.

### BACKGROUND

1. Field of the Invention

This invention relates generally to programmable devices, such as static-random-access-memory-based (SRAM-based) field-programmable gate arrays (FPGAs), programmable logic devices (PLDs), or other reconfigurable logic (RL) devices. More specfically, the invention provides an apparatus and method for protecting configuration data, also referred to herein as Intellectual Property, within such a programmable device.

2. Description of the Related Art

FPGAs, PLDs, and other RL devices have become increasingly popular as building blocks in electronic systems because they are easy to design and then modifly, they are capable of rapid prototyping, they are economical for low-volume production, they provide lower startup costs, which leads to lower financial risk in comparison to fully-customized application-specific integrated circuits (ASICs), there is generally an availability of sophisticated design and debugging tools, and these devices provide the ability of in-circuit reprogrammability. Applications for these types of programmable devices includes, for example, in circuit emulators, programmable controllers, communication transceivers, and encryption/decryption devices, to name but a few.

Tutorial overviews and architectural details of programmable devices, such as FPGAs, can be found in a number of books and papers, such as: S. Brown et al., Field-Programmable Gate Arrays, Kluwer Academic Publishers, Norwell, Mass., 1992; J. Oldfield and R. Dorf, Field Programmable Gate Arrays, Wiley, N.Y, 1995; J. Rose, A. El Gamal and A. Sangiovanni-Vincentelli, “Architecture of field-programmable gate arrays,” IEEE Proceedings, vol. 81, pp. 1013-1029, Jul. 1993; R. J. Francis, “A tutorial on logic synthesis for lookup-table based FPGAs,” IEEE/ACM International Conference on Computer-Aided Design (ICCAD-92), pp. 40-47, 8-12 Nov. 1992; J. Rose, “FPGA and CFPGA architectures: a tutorial,” IEEE Design and Test of Computers, vol. 13, Issue 2, pp. 42-57, Summer 1996; J. Villasenor and B. Hutchings, “The flexibility of configurable computing,” IEEE Signal Processing Magazine, vol. 15, pp. 67-84, Sep. 1998; P. Chow, S. O. Seo, J. Rose, K. Chung, G. Páez-Monzón and I. Rahardja, “The design of an SRAM-based field-programmable gate array—part I: architecture,” IEEE Transactions on Very Large Scale Integration (VLSI) Systems, vol. 7, pp. 191-197, Jun. 1999. FPGA applications for software radios can be found in a paper by M. Cummings, “FPGA in the software radio,” IEEE Communications Magazine, pp. 108-112, Feb. 1999.

One particular type of programmable device is the SRAM-based FPGA. Basically, an SRAM-based FPGA is a one-chip programmable device comprising a number of input/output (I/O) peripheral cells, an array of user-configurable logic blocks, a network of interconnect resources (wire segments, crossbar switches, etc.), and an on-chip static random-access memory (SRAM). The I/O peripheral cells provide an interface between internal components of the FPGA and the circuit outside the chip (i.e., external circuits). The logic blocks and interconnect resources are programmable. The logic blocks perform logical functions as defined by the user (or programmer) of the FPGA. Desired logic blocks and I/O peripheral cells are interconnected by the interconnect resources, and the interconnect topology is controlled by selectively turning on appropriate crossbar switches. Information necessary to configure the logic blocks and to control the crossbar switches is collectively referred to as the configuration data. The configuration data in an SRAM-based FPGA is stored in the on-chip SRAM.

To enable the FPGA to perform the logical task defined by the user, the user specifies the configuration data necessary to program the FPGA to carry out the desired task. Computer synthesis tools are typically utilized by the user to define this configuration data. The sequence of configuration data is highly task-specific, and in essence converts the general purpose FPGA into a special-purpose device. Because the FPGA can be programmed in myriad ways to carry out any number of tasks, the configuration data necessary to program the FPGA into a particular special-purpose device is highly-valuable, and is generally viewed as proprietary to the user who designed the configuration data. Thus, the configuration data is an intellectual property of the user, and it is important to provide mechansims to safeguard this data.

Since SRAM belongs to a class of volatile memory, configuration data are typically lost upon removal of power to the FPGA. Whenever the FPGA is powered up, or is in the reset condition, or is forced to be in the reconfiguration mode, configuration data are required to be downloaded into the on-chip SRAM. In most FPGA-based systems used today, the configuration data are located outside the FPGA and stored in a read-only memory (ROM), or an erasable programmable ROM (EPROM), or an electrically EPROM (EEPROM), or some other nonvolatile storage devices. It is also possible to load configuration data sequences into the target FPGA (or other type of programmable device) through a wireless communication link, such as in a software-defined radio having an RF link

Suppose then that an electronic product having such a programmable device, such as an SRAM-based FPGA, is designed and manufactured by a particular company, referred to hereafter as the inventor company. A competitor, referred to hereafter as the rival company, may want to clone the inventor company's electronic product by utilizing reverse-engineering techniques in order to gain some business advantages, such as lower design cost or faster time-to-market of the cloned product. In this situation, if the configuration data for the programmable device is placed outside the FPGA, such as in a ROM, the rival company can then easily retrieve the configuration data by reading the contents of the ROM. The intellectual property of the inventor company as embodied in the configuration data for the FPGA can then be easily copied and exploited by the rival company.

In general, intellectual property rights embodied in the configuration data, software to produce that configuraiton data, and electronic devices programmed with the configuration data, can be protected within the legal framework of patents and/or copyrights. If in the hypothetical set forth above, the rival company's electronic product is based on patented or copyrighted intellectual properties of the inventor company, and if the inventor company can demonstrate that this is the case, then the inventor company can take appropriate legal actions against the rival company. A known techniques that may assist the inventor company in identifying and then protecting its patented/copyrighted intellectual properties includes authorship identification of FPGA configuration data sequences through the use of watermarking techniques. For example, such techniques are described in J. Lach, W. H. Mangione-Smith and M. Potkonjak, “FPGA fingerprinting techniques for protecting intellectual property,” 1998 IEEE Custom Integrated Circuits Conference, pp. 299-302, May 11-14, 1998; J. Lach, W. H. Mangione-Smith and M. Potkonjak, “Signature hiding techniques for FPGA intellectual property protection,” 1998 IEEE/ACM International Conference on Computer-Aided Design, pp. 186-189, Nov. 8-12, 1998.

Although patents and copyrights can be effective means for intellectual property protection of these types of programmable devices, in many circumstances inventor companies may want to prevent rival companies from successfully reverse-engineering their products at the very beginning. Such a strategy offers the following advantages over intellectual property protection based solely on legal means: (1) protection of the inventor companies' non-financial loss, because any cloned products that appear in the market may damage the company's reputation and customer relations; (2) avoidance of possible failure to prove that rival companies' cloned products are based on protected intellectual properties of inventor companies, which includes the inherent risk and uncertainties involved in any litigation proceeding; (3) avoidance of high costs incurred in analyzing cloned products, gathering evidence, and taking legal proceedings against rival companies; and (4) protection of the inventor company's intellectual properties during the time between patent filings and publications.

Known techniques for providing security in programmable devices against reverse engineering of the configuraiton data includes the following methods. The first method, mentioned by J. Oldfield and R. Dorf in Field Programmable Gate Arrays, Wiley, N.Y., 1995, comprises the steps of (a) downloading the configuration data from an external source into the FPGA (or other programmable device), (b) removing the external source from the circuit board on which the FPGA resides, (c) turning off the read-back mode of the FPGA, so that the content in the on-chip SRAM cannot be retrieved from outside the FPGA, and (d) always keeping the FPGA power on. This first method removes the need for an on-board configuration data storage device and instructs the FPGA not to disclose the content of the on-chip SRAM. Security of the intellectual property is therefore ensured. This method, however, has the disadvantages that circuit power has to be maintained throughout the operating life of the product and that reprogrammability of the FPGA has to be sacrificed.

The second known method for protecting configuration data against reverse engineering was disclosed by K. Austin in U. S. Pat. No. 5,388,157 entitling “Data security arrangements for semiconductor programmable devices,” issued Feb. 7, 1995 and assigned to Pilkington Micro-Electronics Limited, United Kingdom. In this patent, the configuration data sequence is first encrypted by scrambling it with a periodic pseudo-random (PN) code, wherein the PN code is generated by a feedback shift register with a given key. The encrypted configuration data is then stored in on-board storage device(s) on the programmable device. A special type of FPGA is used with this method that includes an extra device that decrypts the encrypted configuration data, and a nonvolatile memory that stores a decryption key. When the FPGA is powered up, or is in the reset condition, or is in the reconfiguration mode, the encrypted configuration data is loaded into the FPGA. The decryption device then decrypts the incoming encrypted configuration data based on the key stored in the nonvolatile memory. The original configuration data is thereby recovered and then transferred to the on-chip SRAM for proper operation of the FPGA.

Using this method, a rival company cannot decode the on-board encrypted configuration data unless the key is obtained from the inventor company, or, in a very rare case, correctly guessed. Notice that in this method, the rival company can immediately identify that the configuration data sequence it obtains through reverse engineering is an encrypted one, because direct transfer of this encrypted sequence into a normal FPGA cannot make the cloned product functional in any manner. In this known technique, the entire configuration data sequence is encrypted.

### SUMMARY

A method an apparatus for protecting a configuration data sequence from reverse engineering is provided. The configuration data sequence includes a plurality of configuration bits and is used to configure the operation of a programmable device, such as an FPGA or other reconfigurable logic. According to a method of the present invention, the configuration bits of the configuration data sequence are partially encrypted by altering some, but not all, of the bits, and subsequently storing the partially-encrypted configuration data sequence external to the programmable device. Corresponding decryption information is then stored within the programmable device, which decrypts the partially-encrypted configuration data sequence using the decryption information stored therein to thereby configure internal logic of the programmable device.

### BRIEF DESCRIPTION OF THE DRAWINGS

FIG. 1 is a block diagram of a programmable apparatus according to the present invention;

FIG. 2 is a diagram depicting a first method of partially encrypting/decrypting a configuration data sequence for use with the apparatus of FIG. 1;

FIG. 3 is a block diagram of another programmable apparatus according to the present invention;

FIG. 4 is a diagram depicting a first method of partially encrypting/decrypting a configuration data sequence for use with the apparatus of FIG. 3;

FIG. 5 is a block diagram of another programmable apparatus according to the present invention;

FIG. 6 is a diagram depicting a first method of partially encrypting/decrypting a configuration data sequence for use with the apparatus of FIG. 5;

FIG. 7 is a diagram depicting a second method of decrypting a configuration data sequence for use with the apparatus of FIG. 1;

FIG. 8 is a diagram depicting a third method of decrypting a configuration data sequence for use with the apparatus of FIG. 1; and

FIG. 9 is a diagram depicting a fourth method of decrypting a configuration data sequence for use with the apparatus of FIG. 1.

### DETAILED DESCRIPTION OF THE DRAWINGS

A system and method for protecting a configuration data sequence against successful reverse engineering in a programmable device, such as an FPGA, PLD, or other reconfigurable logic (RL), is disclosed herein and described in conjunction with the drawing figures set forth and described in more detail below. Using this system and method, it is preferable that only a part of the configuration data sequence is encrypted, although in other embodiments it is possible that the entirety of the configuration data sequence is encrypted, and in still other embodiments it is possible that the configuration data sequence may not be encrypted at all. This invention protects a company's products from being reverse engineered and cloned by rivals by injecting uncertainty into the process of encrypting and decrypting the configuraiton data.

For example, if a rival company directly used the configuration data sequence stored in a programmable device according to the present invention to build a cloned product, then it is possible that the cloned product could perform the same expected function to a certain degree of correctness but not in a manner that was absolutely error-free. Without prior approval of the company employing the present invention, and without additional information provided therefrom, imperfections that exist in the “unchecked” cloned product prevent it from functioning error-free. The company employing the present invention has full discretion to decide where to place the imperfections inside the unchecked cloned product by virtue of its selection of which bits in the data sequence to encrypt. Preferably, these imperfections are placed where they are difficult to be located by the rival company. The unchecked cloned product, which bears hidden imperfections deliberately embedded by virtue of the partially-encrypted configuration data sequence, thus requires thorough debugging. Preferably, this debugging process requires considerable effort, thereby increasing the reverse-engineering cost and delaying time to market for the rival.

The idea of partially encrypting the configuration data sequence is thus capable of deterring rival competitors from trading cloned products based on uncertainty in successful reverse-engineering efforts. Intellectual properties of companies employing this technique are thus protected by the introduction of uncertainty into rival companies' cloned products. Furthermore, even in the case where the configuration data sequence is not encrypted at all, the use of this technique in at least some of a company's products leaves the rival uncertain whether or not the seemingly functional cloned product is absolutely error-free. Therefore, since the identity of the encrypted data versus the unencrypted data is unknown to the rival, as is the corresponding effect on the operation of the device, it is possible to employ a variety of partial encryption schemes, as well as full encryption and even non-encryption, and yet still provide a level of uncertainty that makes reverse engineering very difficult.

In the preferred system of the present invention in which the configuration data sequence is partially encrypted, the resultant encrypted sequence (containing both the encrypted and non-encrypted data bits) is stored in a storage means outside a target programmable device. The decryption information is stored in the programmable device. When power is applied to the programmable device, or it is placed in a reset condition, or it is put into a reconfiguration mode, the encrypted sequence is loaded into the programmable device. The programmable device then decrypts the partially encrypted sequence based on the decryption information stored therein. The decrypted configuration data sequence is then used to configure the programmable device for performing the task specified by the user.

Two preferred approaches that enable decryption of encrypted (either partially or fully) configuration data sequences in a programmable device are described in more detail below. In the first approach, termed the “modification” approach, the original configuration data sequence is recovered in the target programmable device by modifying the encrypted configuration data sequence according to: (i) the content of the encryption sequence and (ii) decryption information stored inside the programmable device. In the second approach, termed the “overwrite” approach, the original configuration data sequence is recovered in the target programmable device by overwriting selected portions of the encrypted configuration data sequence with pre-programmed content stored inside the programmable device, regardless of the original content of the encrypted sequence. Each of these two methodologies is described in more detail with reference to the drawing figures.

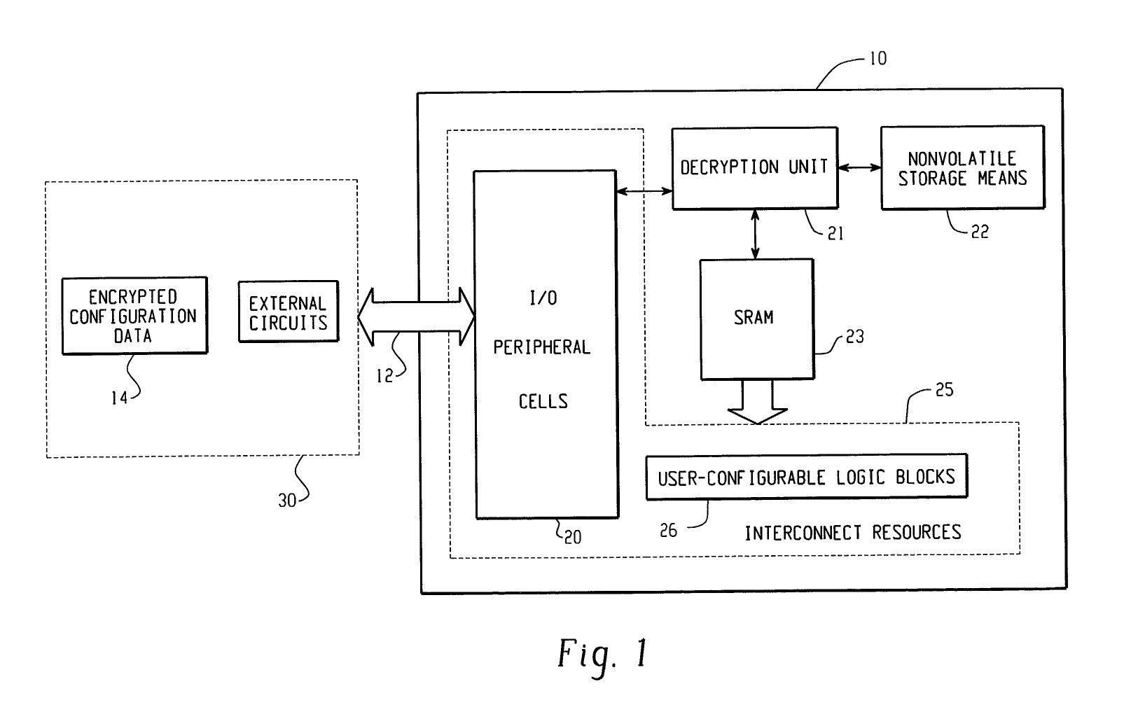

An SRAM-based FPGA embodiment of the present invention that employs the modification approach is set forth in FIG. 1. The SRAM-based FPGA 10, being a one-chip device, essentially comprises I/O peripheral cells 20, user-configurable logic blocks 26, interconnect resources 25, a decryption unit 21, a nonvolatile storage means 22, and a SRAM module 23. The SRAM module 23 stores the configuration information for the FPGA 10. The interconnect resources 25 and the user-configurable logic blocks 26 employ the configuration information to enable the FPGA 10 to perform the task defined by the user. The interconnect resources 25 are distributed over the I/O peripheral cells 20 and the user-configurable logic blocks 26. The I/O peripheral cells 20 are responsible for interfacing internal components of the FPGA 10 with external circuits 30, including circuits that store the encrypted configuration data sequence 14.

The circuit shown in FIG. 1 operates as follows. Prior to inserting the FPGA 10 into a target electronic system, the nonvolatile storage means 22 is programmed and loaded with a secret sequence on which decryption of the configuration data sequence is based. The nonvolatile storage means 22 can be a one-time or many-time programmable device. Since the nonvolatile storage means 22 is a nonvolatile memory, information stored therein is not lost upon removal of the power of the FPGA 10. After programming the nonvolatile storage means 22, the FPGA 10 can be inserted into the target electronic system. When power is applied to the system, or when the reset or reconfiguration modes of the device are asserted, the encrypted configuration data sequence stored in some external circuit 14 is loaded into the FPGA 10 via the I/O peripheral cells 20. The encrypted configuration data sequence is processed and decrypted by the decryption unit 21 based on the secret sequence stored in the nonvolatile storage means 22. The decrypted configuration data sequence is thereafter loaded to the SRAM module 23 in order to set the configuration of the FPGA 10. The FPGA 10 can then execute the desired operation as defined by the user.

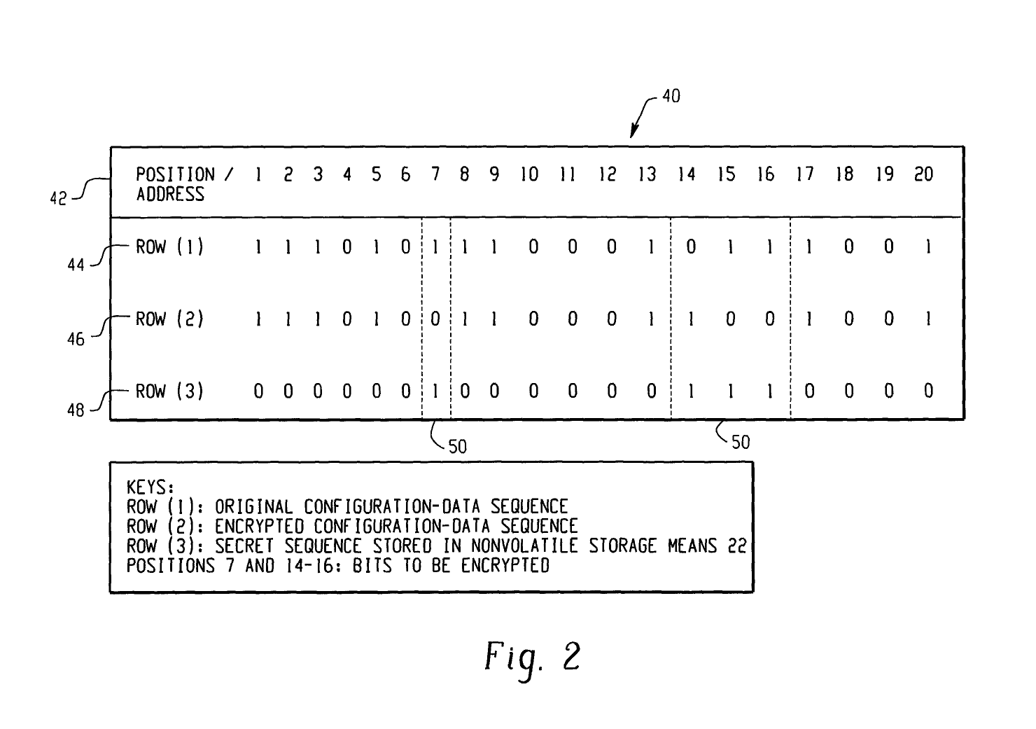

FIG. 2 is a diagram depicting a first method of partially encrypting/decrypting a configuration data sequence for use with the apparatus of FIG. 1. This figure depicts the “modification” approach referred to above. The top line 42 of the chart 40 shows the bit position (or address) of the individual bits contained within the configuration data sequence 44, the encrypted data sequence 46, and the secret sequence 48. The original configuration data sequence 44, which is shown in Row (1), is a string of binary-valued data taking on logic values of either 1 or 0. In the example shown in FIG. 2, it is desired to encrypt the data at positions 7 and 14-16 (marked as 50). The user can then encrypt these selected data 50 by toggling the logic values therein. Toggling the logic value is herein defined as changing the logic value 1 to 0 and vice versa, and thus is an example of the “modification” approach.

The encrypted configuration data sequence 46 is shown in Row (2). To recover the original configuration data sequence 44 from the enctypred sequence 46 in the FPGA 10, the secret sequence 48 to be stored in the nonvolatile storage means 22 is constructed as follows. At positions 7 and 14-16 (the selected encryption bits 50) the user assigns the value “1” to the bits of these positions. In the other, non-selected positions, “0's” are assigned to the secret sequence 48. The original configuration data sequence is then recovered by the following method: (1) read the encrypted data sequence 46 from the external location 14; (2) read the secret sequence 48 from the non-volatile storage means 22; (3) toggle the logic values of the encrypted configuration data at the positions where corresponding data in the secret sequence at the same positions equal 1's; and (4) leave the remainder of the encrypted data sequence 46 unchanged. This toggle operation can be implemented, for example, by EXCLUSIVE-ORing the encrypted configuration data sequence 46 with the secret sequence 48 stored in the nonvolatile storage means 22.

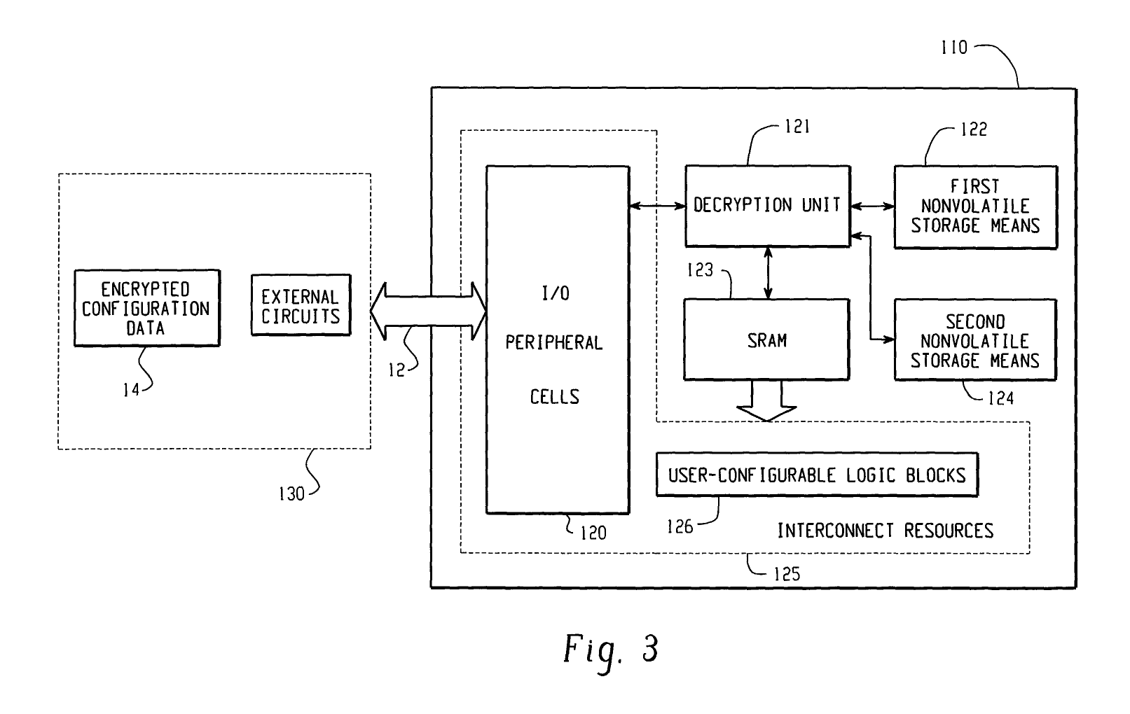

FIG. 3 is a block diagram of another programmable apparatus according to the present invention. Like FIG. 1, the programmable device shown in FIG. 3 is also an SRAM-based FPGA. This device 110 preferably employs the “overwrite” approach mentioned above. The FPGA 110, being a one-chip device, essentially comprises I/O peripheral cells 120, user-configurable logic blocks 126, interconnect resources 125, a decryption unit 121, a first nonvolatile storage means 122, a second nonvolatile storage means 124, and a SRAM module 123. The SKAM module 123 is used to store the configuration information of the FPGA 110. The interconnect resources 125 and the user-configurable logic blocks 126 employ the configuration information to enable the FPGA 110 to perform the task defined by the user. The interconnect resources 125 are distributed over the I/O peripheral cells 120 and the user-configurable logic blocks 126. The I/O peripheral cells 120 are responsible to interface internal components of the FPGA 110 with external circuits 130.

The circuitry shown in FIG. 3 operates as follows. Prior to inserting the FPGA 110 into a target electronic system, the first nonvolatile storage means 122 and the second nonvolatile storage means 124 are programmed by the user, and each of them is loaded with a secret sequence on which decryption of the configuration data sequence is based. The first and second nonvolatile storage means 122, 124 can be one-time or many-time programmable devices. Since the first and second nonvolatile storage means 122, 124 are nonvolatile memories, information stored therein is not lost upon removal of power to the FPGA 110. After programming the first and second nonvolatile storage means 122, 124, the FPGA 110 can be inserted into the target electronic system. When power is applied to the system, or when the reset or reconfiguration mode is asserted on the device 110, the encrypted configuration data sequence 14 is loaded into the FPGA 110 via the I/O peripheral cells 120. The encrypted configuration data sequence is processed and decrypted by the decryption unit 121 based on secret sequences stored in the first and second nonvolatile storage means 122, 124. The decrypted configuration data sequence is thereafter loaded to the SRAM module 123. The FPGA 110 can then execute the desired operation as defined by the user.

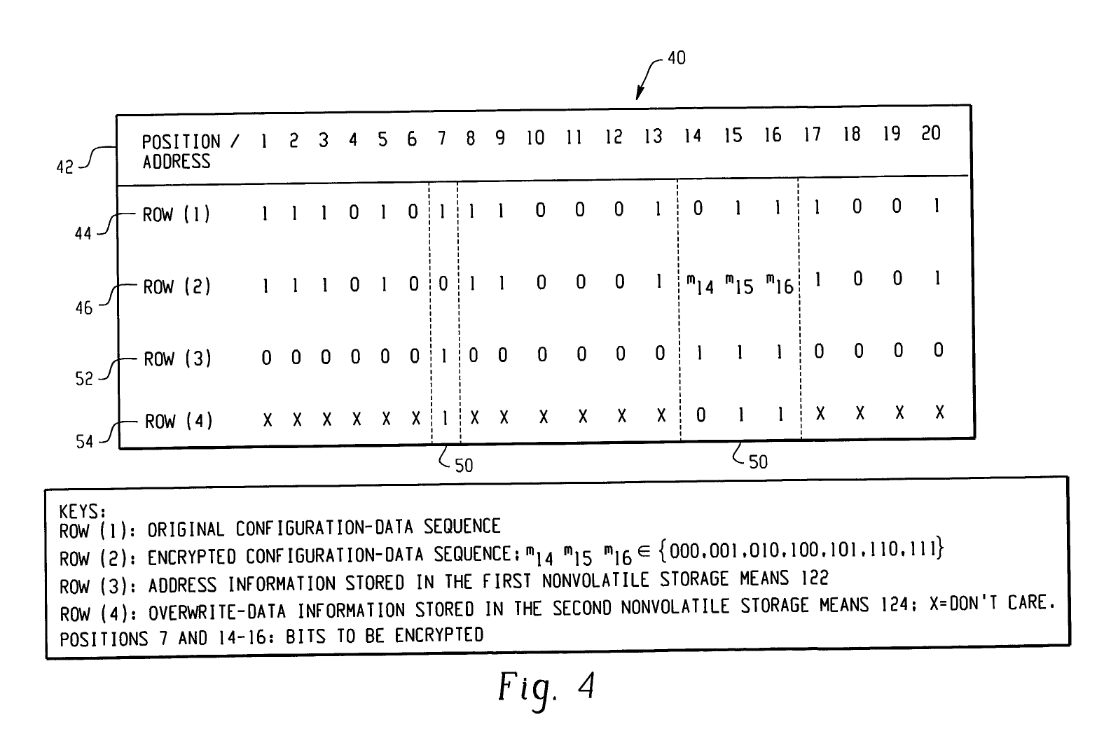

FIG. 4 is a diagram depicting a first method of partially encrypting/decrypting a configuration data sequence for use with the apparatus of FIG. 3. This figure depicts the “overwrite” approach referred to above. Similar to FIG. 2, the top line of the chart in FIG. 4 shows the bit position (or address) of the individual bits contained within the configuration data sequence 44, the encrypted data sequence 46, and also includes addressing information 53 stored in the first nonvolatile storage means 122, and overwrite data information stored in the second nonvolatile storage meanse 124.

The original configuration data sequence, which is shown in Row (1) 44, is a string of binary-valued data taking on logic values of either 1 or 0. In the example shown in FIG. 4, it is desired to encrypt the data at positions 7 and 14-16 (shown as 50). The partially-encrypted configuration data sequence is shown in Row (2) 46. The data at positions 7 and 14-16 of the encrypted configuration data sequence 46 are to be different from the corresponding data of the original configuration data sequence 44. At other positions, data in both encrypted and original configuration data sequences are the same. Note that the combined logic value of the encrypted sequence at positions 14-16 (labeled as m14, m15, m16) can be chosen from one out of seven combinations, i.e., m14, m15, m16 may be equal to 000, 001, 101, 100, 101, 110 or 111 in the encrypted sequence 46. The value 011 is excluded from this list for the purpose of encryption, since this is the value of these bits in the original configuration data sequence 44.

The decryption method is described as follows. Before installing the FPGA 110 into the target electronic system, the user assigns the first nonvolatile storage means 122 with logic values of “1” on the 7^{th} and 14th-16th positions (i.e., the positions that are encrypted) and 0's otherwise where a “1” indicates the position/address of the configuration data sequence 44 that is encrypted. Row (3) of FIG. 4 52 shows the address-information sequence stored in the first nonvolatile storage means 122. The overwrite data is stored in the second nonvolatile storage means 124. Row (4) is the overwrite-data sequence stored in the second nonvolatile storage means 124. Note that the data stored in positions 7 and 14-16 are 1 and 011, respectively, which are the same as corresponding data in the original configuration data sequence 44. In positions other than 7 and 14-16, data stored in the second nonvolatile storage means 124 are irrelevant to decryption so that any logic values can be stored.

The encrypted configuration data sequence 46 can be decrypted in the following way: (i) acquire the encrypted configuration data sequence 46; (ii) deteremine which address positions of the encrypted sequence 46 are to be overwritten by retreiveing the data stored in the first nonvolatile storage means 122—the address bits that store a “1” are the bit positions to be overwritten; and (iii) the corresponding positions in the encrypted configuration data sequence 46 are overwritten with data stored in the same positions of the second nonvolatile storage means 124. The original configuration data sequence 44 is thereby recovered.

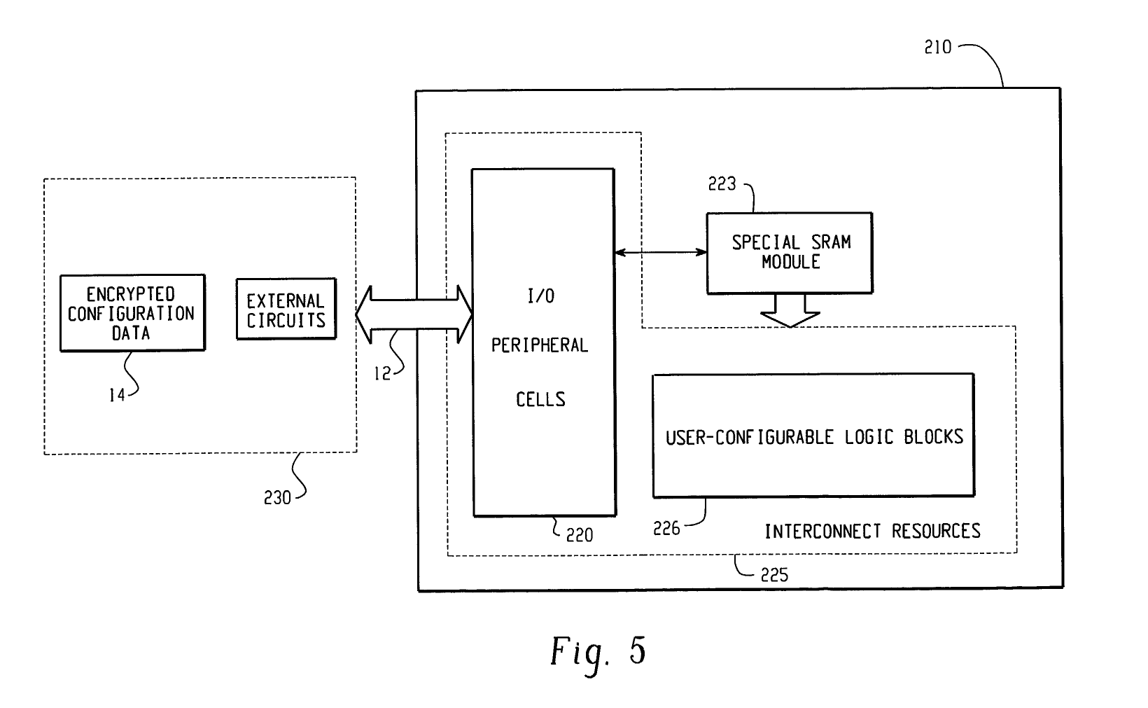

FIG. 5 is a block diagram of another programmable apparatus according to the present invention. Like FIGS. 1 and 3, this apparatus is also an SRAM-based FPGA. The FPGA 210, being a one-chip device, essentially comprises I/O peripheral cells 220, user-configurable logic blocks 226, interconnect resources 225, and a special SRAM module 223. Memory cells of the special SRAM module 223 are one-time programmable and the user can program selected memory cells to stick to chosen logic values while the rest of memory cells remain as normal read/write SRAM cells. These selected memory cells can be viewed as memory cells having stuck-at faults (deliberately introduced, however). The SRAM module 223 can be implemented, for example, by including antifuse device(s). The function of the special SRAM module 223 is to store the configuration information of the FPGA 210. The interconnect resources 225 and the user-configurable logic blocks 226 employ the configuration information to enable the FPGA 210 to perform the task defined by the user. The interconnect resources 225 are distributed over the J/O peripheral cells 220 and the user-configurable logic blocks 226. The I/O peripheral cells 220 are responsible to interface internal components of the FPGA 210 with external circuits 230.

The circuitry shown in FIG. 5 operates as follows. Prior to inserting the FPGA 210 into a target electronic system, selected memory cells of the special SRAM module 223 are programmed to emulate stuck-at faults. The stuck-at faults, once introduced, permanently reside in the special SRAM module 223 even upon removal of the power of the FPGA 210. After programming the special SRAM module 223, the FPGA 210 can be inserted into the target electronic system. When power is applied to the device, or when the reset or reconfiguration mode is asserted, the encrypted configuration data sequence 14 stored somewhere in external circuits 230 is loaded into the FPGA 210 via the I/O peripheral cells 220. The encrypted configuration data sequence is directly loaded into the special SRAM module 223. The original configuration data sequence, as will be shown, is recovered immediately and stored in the special SRAM module 230. The FPGA 210 can then execute the desired operation as defined by the user.

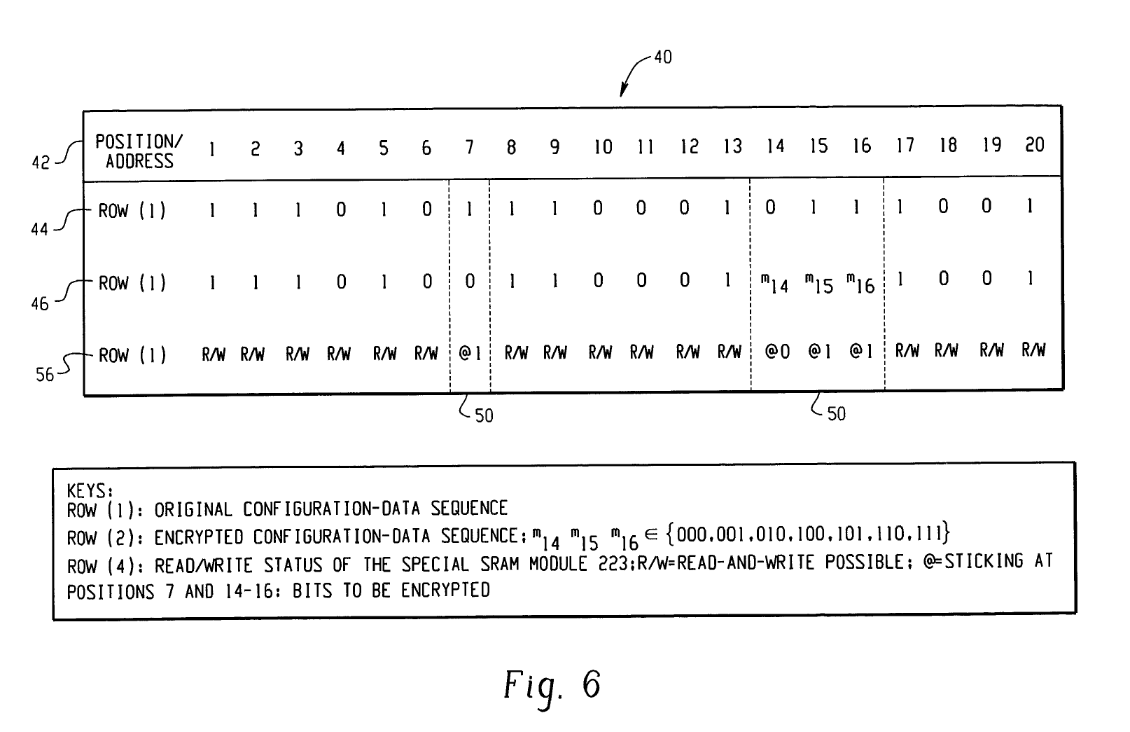

FIG. 6 is a diagram depicting a first method of partially encrypting/decrypting a configuration data sequence for use with the apparatus of FIG. 5. The methodology depicted here is similar to the overwrite approach, although it is implemented in a different manner. The original configuration data sequence, which is shown in Row (1) 44, is a string of binary-valued data taking on logic values of either 1 or 0. In the example shown in FIG. 6, it is desired to encrypt the data at positions 7 and 14-16 (labeled as 50). The encrypted configuration data sequence is shown in Row (2) 46. Read/write status of corresponding memory cells in the SRAM module 223 are shown in Row (3) 56. At positions 7 and 14-16, memory cells of the SRAM module 223 are programmed to stick to logic values 1 and 011. These values are the same as the corresponding values in the original configuration data sequence (compare 56 and 44).

By loading the encrypted configuration data sequence directly into the SRAM module 223, the original configuration data sequence is immediately recovered. For the encrypted configuration data sequence, data at positions 7 and 14-16 are different from corresponding data of the original configuration data sequence. These data are ignored, however, when the encrypted sequence is read into the special SRAM module 223, since these positions have been configures as stuck-at faults corresponding to the values of the original configuration data sequence 44. At the other positions, data in both encrypted and original configuration data sequences are the same, and the encrypted sequence is simply read into the corresponding positions of the SRAM module 223. Note that the combined logic value of the encrypted sequence at positions 14-16 can be chosen from one out of seven combinations, i.e., 000, 001, 101, 100, 101, 110 and 111. The value 011 is preferably excluded from this list for the purpose of encryption, although it could be used.

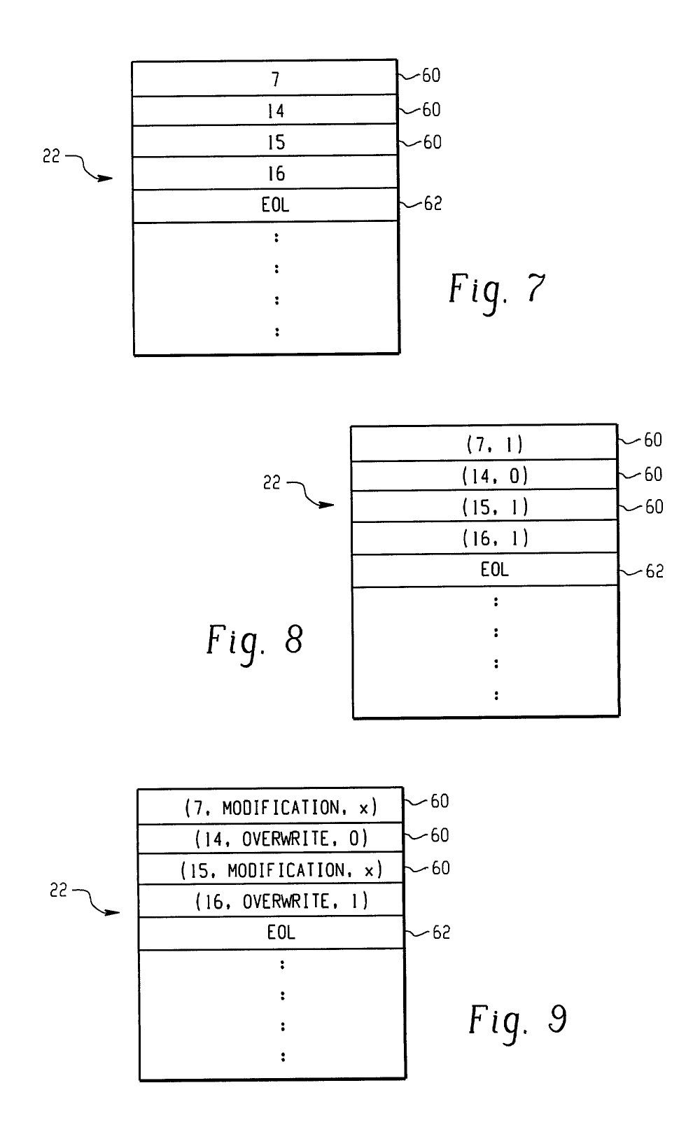

FIG. 7 is a diagram depicting a second method of decrypting a configuration data sequence for use with the apparatus of FIG. 1. This diagram depicts an alternative of the “modification” methodology discussed above with reference to FIG. 2. This methodlogy is similar to that described above with reference to FIG. 2, except that now the decryption information is stored in the nonvolatile storage means 22 as a list containing the positions/addresses 60 of the encrypted configuration data sequence that are to be modified. One way to achieve this modification would be to toggle the bit values at these positions. The entry 62 that follows the end of the address list is an EOL indicator, wherein EOL stands for end of list. In case the maximum number of entries that the nonvolatile storage means 22 comprises is exactly the number of terms in the address list, the EOL indicator is not stored in the nonvolatile storage means 22.

The original configuration data sequence can be recovered in the FPGA 10 by the following operation: (1) toggle the logic values of the encrypted configuration data at the positions indicated by the address information stored in the nonvolatile storage means 22, and (2) the rest of data bits of the encrypted configuration data sequence are kept unchanged.

FIG. 8 is a diagram depicting a third method of decrypting a configuration data sequence for use with the apparatus of FIG. 1. This is an alternative to the “overwrite” approach. The decryption method is described as follows. Before installing the FPGA 10 into a target electronic system, the user programs the nonvolatile storage means 22. Nonvolatile storage means 322 comprises a plurality of entries 60. Decryption information stored in the nonvolatile storage means 322 is a list containing ordered pairs 60 (address, logic value), wherein the logic value is to be overwritten on the encrypted configuration data at the address/position in order to recover the original configuration data sequence. The entry that follows the end of the ordered-pair list is an EOL indicator, wherein EOL stands for end of list. In case the maximum number of entries that the nonvolatile storage means 322 comprises is exactly the number of terms in the ordered-pair list, the EOL indicator is not stored in the nonvolatile storage means 322.

FIG. 9 is a diagram depicting a fourth method of decrypting a configuration data sequence for use with the apparatus of FIG. 1. This method is a combination of the modification and overwrite approaches. In the example shown in FIG. 9, it is supposed that the modification approach is used to decrypt data at positions 7 and 15, and that the overwrite approach is employed for data at positions 14 and 16.

According to this methodology, the nonvolatile storage means 22 comprises a plurality of entries 60. Decryption information stored in the nonvolatile storage means 22 is a list containing ordered 3-tuples (address, modification/overwrite mode, logic value), wherein the mode indicates which approach, the modification approach or the overwrite approach, is to be used for the particular address entry. The entry that follows the end of the 3-tuple list is an EOL indicator, wherein EOL stands for end of list. In case the maximum number of entries that the nonvolatile storage means 322 comprises is exactly the number of terms in the 3-tuple list, the EOL indicator is not stored in the nonvolatile storage means 322.

In this example, the first entry of the list is “(7, modification, x)”, meaning that at the 7th position, the data of the encrypted configuration data sequence is to be toggled. The “x” in the entry means that any logic value, 1 or 0, can be stored as this value is irrelevant to decryption. The second entry is “(14, overwrite, 0)”. It means that the bit at the 14th position is to be overwritten with a logic value “0”, which is indicated in the third element of this entry. Third and fourth entries can thereupon be interpreted in a straightforward manner. By performing operations according to the decryption information stored in nonvolatile storage means 322, the original configuration data sequence can be recovered.

The preferred embodiments described with reference to the drawing figures are presented only to demonstrate an example of the invention. Other elements, steps, methods and techniques that are insubstantially different from those described herein are also within the scope of the invention.

We claim:

1. A method of protecting a configuration data sequence against reverse engineering, wherein the configuration data sequence includes a plurality of configuration bits, and is used to configure the operation of a programmable device, the method comprising the steps of:
partially encrypting the configuration bits of the configuration data sequence by altering some, but not all, of the configuration bits;
storing the partially-encrypted configuration data sequence in a memory external to the programmable device;
storing decryption information for the partially-encrypted configuration data sequence in the programmable device;
loading the partially-encrypted configuration data sequence into the programmable device;
decrypting the partially-encrypted configuration data sequence using the decryption information stored in the programmable device; and
configuring internal logic of the programmable device using the decrypted configuration data sequence.

2. The method of claim 1, wherein the partially-encrypted configuration data sequence is loaded into the programmable device via a wireless connection.

3. The method of claim 1, wherein the decryption information includes a sequence of bits that correspond to the bits of the configuration data sequence, and wherein each bit in the sequence of bits of the decryption information provides an indication of which bits in the configuration data sequence are encrypted.

4. The method of claim 3, wherein the decrypting step further comprises the step of:
toggling logic values of the bits in the partially-encrypted configuration data sequence that are indicated as being encrypted in the sequence of bits of the decryption information.

5. The method of claim 3, wherein the decrypting step further comprises the step of:
modifying logic values of the bits in the partially encrypted data sequence that are indicated as being encrypted in the sequence of bits of the decryption information using a set of logic values stored in the programmable device.

6. The method of claim 4, wherein the toggling step further comprises the step of:
executing an exclusive-or function between the partially-encrypted configuration data sequence and the sequence of bits of the decryption information.

7. The method of claim 1, wherien the storing decryption information step further comprises the steps of:
storing a first secret sequence in the programmable device, wherein the first secret sequence comprises a sequence of bits that correspond to the bits of the configuration data sequence, and wherein each bit of the first secret sequence provides an indication of which bits in the configuration data sequence are encrypted; and
storing a second secret sequence in the programmable device, wherein the second secret sequence comprises a sequence of bits that correspond to the bits of the configuration data sequence, and wherein the bits of the second secret sequence that correspond to the bits of the configuration data sequence that are encrypted have identical values to the corresponding bits of the configuration data sequence.

8. The method of claim 7, wherein the decrypting step further comprises the step of:
overwritting the bits in the partially-encrypted configuration data sequence using the bits of the second secret sequence that correspond to the bits of the first secret sequence that indicate which bits of the configuration data sequence are encrypted.

9. The method of claim 1, wherein the storing decryption information step further comprises the steps of:
providing a one-time programmable memory device within the programmable device; and
programming selected memory cells of the one-time programmable memory device so as to permanently set the logical values stored in the selected memory cells;
wherein the selected memory cells correspond to the bits of the configuration data sequence that are encrypted and the logic values set in the selected memory cells correspond to the actual logic values of the configuration data sequence.

10. The method of claim 9, wherein the decrypting step further comprises the step of:
loading the partially-encrypted configuration data sequence into the one-time programmable memory device.

11. The method of claim 1, wherein the decryption information comprises a list of bit positions within the configuration data sequence that are encrypted.

12. The method of claim 1, wherein the decryption information comprises a list of ordered pairs, each ordered pair including a first value that indicates a bit position in the partially-encrypted configuration data sequence that is encrypted, and a second value that corresponds to an unencrypted value for the bit position from the configuration data sequence.

13. The method of claim 1, wherein the decryption information comprises a list of ordered tuples, each ordered tuple including a first element that indicates a bit position in the partially-encrypted configuration data sequence that is encrypted, a second element that indicates whether the bit of the partially-encrypted configuration data sequence at the indicated bit position is to be modified or overwritten, and a third element that corresponds to an unencrypted value for the bit position from the configuration data sequence.

14. The method of claim 13, wherein the decrypting step further comprises the steps of:
for each ordered tuple in the list,
determining whether the bit of the partially-encrypted configuration data sequence identified by the first element is to be overwritten or modified by examining the second element of the tuple;
if the bit is to be modified, then toggling the value of the bit at the identified bit position in the partially-encrypted configruation data sequence; and
if the bit is to be overwritten, then overwritting the bit at the identified bit position in the partially-encrypted configuration data sequence using the value in the third element of the tuple.

15. An apparatus for protecting a configuration data sequence from reverse engineering, wherein the configuration data sequence includes a plurality of configuration bits, and is used to configure the operation of a programmable device, comprising:
an encrypted configuration data store external to the programmable device for storing a partially-encrypted configuration data sequence, wherein some, but not all, of the bits in the partially-encrypted configuration data sequence are encrypted;
a decryption memory store within the programmable device for storing decryption information;
an interface for loading the partially-encrypted configuration data sequence from the encrypted configuration data store into the programmable device; and
a decryption unit for decrypting the partially-encrypted configuration data sequence using the decryption information stored in the decryption memory.

16. The apparatus of claim 15, wherein the interface is a wireless interface.

17. The apparatus of claim 15, wherein the decryption information includes a sequence of bits that correspond to the bits of the configuration data sequence, and wherein each bit in the sequence of bits of the decryption information provides an indication of which bits in the configuration data sequence are encrypted.

18. The apparatus of claim 17, wherein the decryption unit decrypts the partially-encrypted configuration data sequence by toggling logic values of the bits in the partially-encrypted configuration data sequence that are indicated as being encrypted in the sequence of bits of the decryption information.

19. The apparatus of claim 17, wherein the decryption unit decrypts the partially-encrypted configuration data sequence by modifying logic values of the bits in the partially-encrypted data sequence that are indicated as being encrypted in the sequence of bits of the decryption information using a set of logic values stored in the programmable device.

20. The apparatus of claim 19, wherein the set of logic values are stored in the decryption memory store.

21. The apparatus of claim 19, wherein the set of logic values are stored in a memory store that is separate from the decryption memory store.

22. The apparatus of claim 15, wherein the decryption memory store includes a first memory store and a second memory store, wherein the first memory store contains a first secret sequence, wherein the first secret sequence comprises a sequence of bits that correspond to the bits of the configuration data sequence, and wherein each bit of the first secret sequence provides an indication of which bits in the configuration data sequence are encrypted, and wherein the second memory store contains a second secret sequence, wherein the second secret sequence comprises a sequence of bits that correspond to the bits of the configuration data sequence, and wherein the bits of the second secret sequence that correspond to the bits of the configuration data sequence that are encrypted have identical values to the corresponding bits of the configuration data sequence.

23. The apparatus of claim 22, wherein the decryption unit decrypts the partially-encrypted configuration data sequence by overwritting the bits in the partially-encrypted configuration data sequence using the bits of the second secret sequence that correspond to the bits of the first secret sequence that indicate which bits of the configuration data sequence are encrypted.

24. The apparatus of claim 15, wherein the decryption memory store includes a one-time programmable memory device in which selected memory cells of the one-time programmable memory device are programmed so as to permanently set the logical values stored in the selected memory cells, wherein the selected memory cells correspond to the bits of the configuration data sequence that are encrypted and the logic values set in the selected memory cells correspond to the actual logic values of the configuration data sequence.

25. The apparatus of claim 24, wherein the decryption unit decrypts the partially-encrypted configuration data sequence by loading the partially-encrypted configuration data sequence into the one-time programmable memory device.

26. The apparatus of claim 15, wherein the decryption information comprises a list of bit positions within the configuration data sequence that are encrypted.

27. The apparatus of claim 15, wherein the decryption information comprises a list of ordered pairs, each ordered pair including a first value that indicates a bit position in the partially-encrypted configuration data sequence that is encrypted, and a second value that corresponds to an unencrypted value for the bit position from the configuration data sequence.

28. The apparatus of claim 15, wherein the decryption information comprises a list of ordered tuples, each ordered tuple including a first element that indicates a bit position in the partially-encrypted configuration data sequence that is encrypted, a second element that indicates whether the bit of the partially-encrypted configuration data sequence at the indicated bit position is to be modified or overwritten, and a third element that corresponds to an unencrypted value for the bit position from the configuration data sequence.

29. The apparatus of claim 28, wherein the decryption unit decrypts the partially-encrypted configuration data sequence by:
for each ordered tuple in the list,
determining whether the bit of the partially-encrypted configuration data sequence identified by the first element is to be overwritten or modified by examining the second element of the tuple;
if the bit is to be modified, then toggling the value of the bit at the identified bit position in the partially-encrypted configruation data sequence; and
if the bit is to be overwritten, then overwritting the bit at the identified bit position in the partially-encrypted configuration data sequence using the value in the third element of the tuple.

30. The apparatus of claim 15, wherein the programmable device is a SRAM-based field programmable gate array (FPGA).

31. The apparatus of claim 15, wherein the programmable device is a reconfigurable logic device.

32. The apparatus of claim 30, wherein the interface includes a plurality of input/output peripheral cells for interfacing between internal elements of the FPGA and a plurality of external circuits.

33. The apparatus of claim 30, wherein the FPGA includes:
a plurality of input/output peripheral cells for interfacing between the FPGA and a plurality of external circuits;
user-configurable logic blocks for performing logical functions as defined by a user of the FPGA;
interconnect elements for connecting the user-configurable logic blocks to the plurality of input/output peripheral cells;
wherein the interconnect elements are configured using the configuration data sequence.

34. The apparatus of claim 30, wherein the decryption memory store is an SRAM memory.

35. The apparatus of claim 30, wherein the decryption memory store is a ROM.
